(19) United States
(12) Patent Application Publication
(10) Pub. No.: US 2015/0289549 A1
(43) Pub. Date: Oct. 15, 2015

(54) Food Seasoning Product Involving Hops

(71) Applicant: Christopher Adam Don, Manville, NJ (US)

(72) Inventor: Christopher Adam Don, Manville, NJ (US)

(21) Appl. No.: 14/608,163

(22) Filed: Jan. 28, 2015

Related U.S. Application Data
(60) Provisional application No. 61/932,734, filed on Jan. 28, 2014.

(51) Int. Cl. A23L 1/223; A23L 1/222; A23L 1/221

(52) U.S. Cl. CPC A23L 1/223; A23L 1/2212; A23L 1/2225; A23L 1/221; A23V 2002/00

(57) ABSTRACT

A food seasoning comprising a mixture hops that have been re-hydrated in an aqueous solution of beer, salt, and zest from a grapefruit measured in specific quantities.

### BACKGROUND OF THE INVENTION

The present invention is in the technical field of a food seasoning composition that essentially is derived from hops, and salt and the zest of a grapefruit in specific quantities.

The purpose of the invention is make a new style of seasoning that will give food a better taste

### SUMMARY OF THE INVENTION

The present invention is a food seasoning comprised of specific quantities of hops, salt and citrus zest.

### BRIEF DESCRIPTION OF THE DRAWINGS

FIG. 1 is a semi-schematic diagram that illustrates the method of the production of the hop salt seasoning from start to finish.

### DETAILED DESCRIPTION OF THE INVENTION

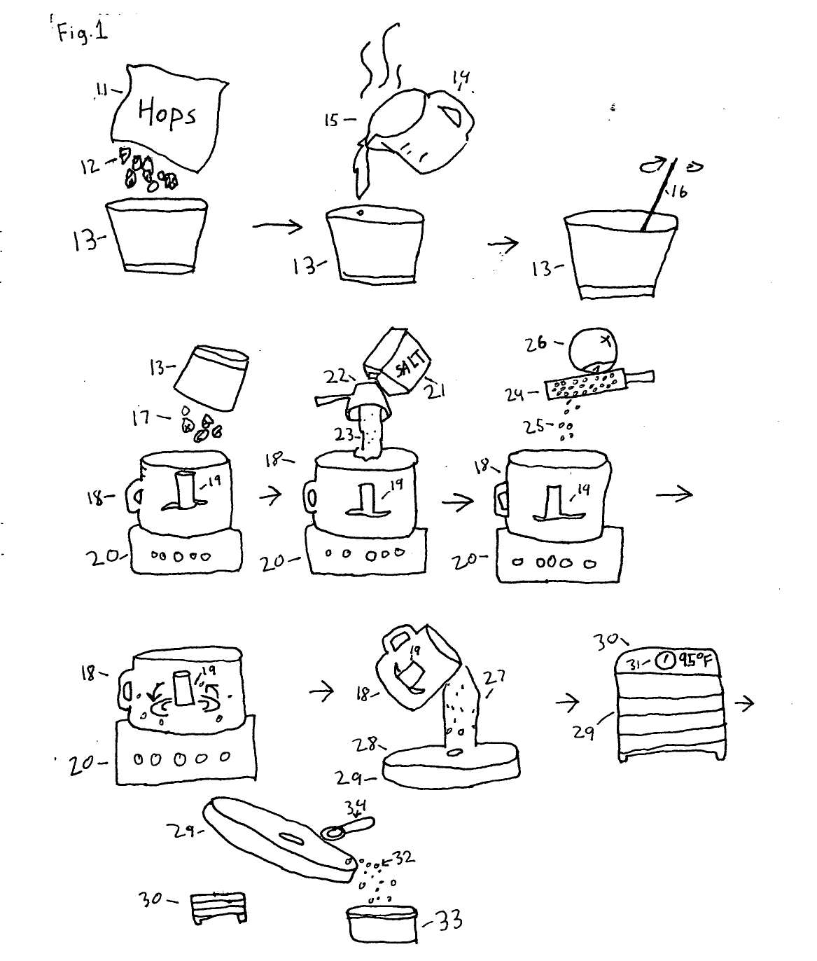

Referring now to the invention referenced in FIG. 1 there is shown a bag 11, suspended above a mixing bowl 13, into which pours hops 12. A jug 14 containing an aqueous solution of beer 15, stirring rod 16 is inserted into the bowl, after which the re-hydrated hops 17 are added to food processor bowl 18 into which food processor blades 19 are inserted. Food processor bowl 18 is itself attached to food processor 20, and salt 23 is emptied from box of salt 21 into measuring cup 22 and into mixing bowl 18. A grapefruit 26 is zested by zester 24 to produce zest 25, which is added to the bowl. The ingredients are processed until the form a processed blend of zest, hops and salt 27, which is placed on a suitable drying surface 28 and placed within food dehydrator shelf 29, which is added to food dehydrator 30. Temperature control setting 34 is then set until seasoning 32 is produced, which is scraped out of food dehydrator shelf 29 with a food grade spoon 31 and into air tight container 33.

Referring now to the invention in more detail, FIG. 1 there is shown a bag 11, suspended above a mixing bowl 13 into which ⅛ to ½ cup of hops 12 is being added. After this, a jug 14 containing between 1/16th to ¼ cup of an aqueous solution of beer 15 is added to the mixture. Stirring rod 16 is employed to rehydrate the hops 12. Taking the re-hydrated hops 17 and adding them to food processor bowl 18 in which processor blades 19 are inserted attaching to the food processor 20, upon which the food processor bowl 18 itself rests. To this a box of salt 21 measures out ½ to 1½ cups of salt 23 into measuring spoon 22, before its added into the mixture in food processor bowl 18. A grapefruit 26 is elevated above food processor bowl 18, and a zester 24 is applied to the grapefruit 26. resulting in the zest 25 of ¼ to 1 whole grapefruit 26. Once the zest 25, salt 23 and re-hydrated hops 17 are all together in food processor bowl 18 and activate the food processor 20 and process until the ingredients are well-blended and have achieved a sand-like consistency becoming a processed blend of zest, hops and salt 27. Removing food processor blades 19 from food processor bowl 18 pour processed blend of zest, hops and salt 27 onto a suitable drying surface 28 that is within food dehydrator shelf 29. This is then added food dehydrator 30 and the temperature control setter 31 should be set for between 85 degrees F. and 105 degrees F. This should be allowed to dehydrate for 4-6 hours and the resulting seasoning 32 is thoroughly dry and free of moisture. Remove the food dehydrator shelf 29 from the food dehydrator 30 scrape seasoning 32 from the food dehydrator shelf 29 with food grade spoon 31 being sure to break up and clumps of seasoning 32 that may still exist and add them into an air tight container 33. The best method of mixing the ingredients would be 1 cup of salt 23, ¼ cup of hops 12, ½ cup of zest 25 from a grapefruit 26 and ⅛th cup of an aqueous solution of beer and water (roughly 50% beer and 50% water), combined together.

In more detail, still referring to the invention of FIG. 1, which is an example recipe that should by no means be considered limiting, the seasoning 32 is comprised of hops 12 that have been re-hydrated in an aqueous solution of beer 15, salt 23 and zest 25.

In further detail, still referring to the invention of FIG. 1 the way this invention works is that it is added to food after it has been cooked, or during the cooking process. The presence of the rehydrated hops 17, the zest 25 of the grapefruit 26 and the salt 23 provide the flavors that combine together to improve the taste of food.

In broad embodiment, the present invention is a food seasoning that makes food taste better than it did without the seasoning.

The advantages of the present invention include without limitation the presence of hops as a cooking spice, and it's myriad of individual hop flavors. While hops 12 have long been used to flavor fermented grain beverages like beer, they have found little purchase in the kitchen. This invention intends to make use of the natural flavors of hops and complements them in such a way that with the zest 25 and the salt 23 that the seasoning 32 will improve the flavor of food.

All objects and ingredients shown in FIG. 1 and in this specification, including any accompanying claims, abstract, and drawings, may be replaced by alternate objects and ingredients which can served the same, equivalent or similar purpose, unless it is directly and explicitly stated otherwise. Thus, unless expressly stated otherwise, each object and ingredient described is only one example of a large series of generic, equivalent or similar objects and ingredients.

Moreover, any element in a claim that does not explicitly state “means for” performing a specified function, or “step for” in regards to performing a specific function, is not to be interpreted as a “means” or “step” clause as specified in 35 U.S.C. §112, paragraph 6. In particular, the use of “step of”, “added to” or “mixed with”, in the claims herein is not at all intended to invoke the provisions of 35 U.S.C. §112, paragraph 6.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. A seasoning comprising: salt, beer, water, grapefruit zest, and hops, wherein the salt is mixed with the water and beer, as well as the grapefruit zest and hops are poured into a food processor and then dehydrated back into a seasoning.

2. The seasoning of claim 1 further comprising: garlic, coriander, pepper, and allspice, wherein these ingredients are disposed with the hops and grapefruit zest.

3. The grapefruit zest can be substituted with the zest of other citrus fruits in equal proportions.
